(19) United States
(12) Patent Application Publication
(10) Pub. No.: US 2024/0040674 A1
(43) Pub. Date: Feb. 1, 2024

(54) INDUCTION COOKING HOB AND METHOD FOR CONTROLLING AN INDUCTION COOKING HOB

(71) Applicant: ELECTROLUX APPLIANCES AKTIEBOLAG, Stockholm (SE)

(72) Inventors: Emanuel URGESE, Forli (IT); Alex VIROLI, Forli (IT); Massimo NOSTRO, Forli (IT); Massimo ZANGOLI, Forli (IT); Filippo MILANESI, Forli (IT); Giacomo CORSI, Forli (IT); Alan MENGOZZI, Forli (IT)

(21) Appl. No.: 18/265,918

(22) PCT Filed: Nov. 24, 2021
(86) PCT No.: PCT/EP2021/082809

§ 371 Date: Jun. 7, 2023

(30) Foreign Application Priority Data
Dec. 8, 2020 (EP) 20212444.2

(51) Int. Cl. H05B 6/06; H05B 6/12

(52) U.S. Cl. CPC H05B 6/065; H05B 6/1272

(57) ABSTRACT

There is described an induction cooking hob (1, 1′, 1″) comprising at least one cooking zone (2) for heating a cooking vessel. The cooking zone (2) comprises at least a first induction coil (3) and a second induction coil (4), the first induction coil (3) and the second induction coil (4) being configured to heat the cooking vessel alone or in collaboration with one another. The induction cooking hob (1, 1′, 1″) further comprises a power unit (6) operatively connected to and configured to power the first induction coil (3) and the second induction coil (4) and a control interface (5) configured to receive a requested power from a user, the requested power defining and/or being indicative about the power to be delivered to the cooking vessel. The power unit (6) is configured to power the first induction coil (3) and the second induction coil (4) such that the first induction coil (3) delivers, in use, a first power ranging between a first minimum deliverable power and a first maximum deliverable power and the second induction coil (4) delivers, in use, a second power ranging between a second minimum deliverable power and a second maximum deliverable power. The power unit (6) is configured to power the first induction coil (3) and the second induction coil (4) according to a respective powering scheme chosen from a set of powering schemes. The power unit (6) is configured to choose the respective powering scheme in function of the requested power and the first minimum deliverable power, the second minimum deliverable power, the first maximum deliverable power and the second maximum deliverable power.

The present invention relates to an induction cooking hob, in particular an induction cooking hob for preparing food products.

Advantageously, the present invention also relates to a method for controlling an induction hob, in particular an induction hob for preparing food products.

There are known induction cooking hobs having at least one cooking zone for heating a cooking vessel being placed onto the cooking zone. Some of the known induction cooking hobs are designed such that the cooking zone comprises at least two induction coils. In the latter case, the cooking vessel is heated by activating only one of both of the induction coils. Some of these induction cooking hobs have a power unit configured to power the induction coils by means of a quasi-resonator architecture.

Even though such induction cooking hobs work satisfyingly well, there is a need felt in the sector to further improve the known induction cooking hobs for optimizing operation of such induction cooking hobs, which have a cooking zone with two induction coils.

In particular, a need is felt in the sector to further improve the induction cooking hobs, in particular the induction cooking hobs, which are based on quasi-resonator architecture, and their operation so as to maximize maximum power delivery and/or a decrease of the pulsed power threshold and/or for suppressing the occurrence of acoustic noise.

One aim of the present invention is to provide for an improved induction cooking hob.

Advantageously, a further aim of the present invention is to provide for an improved method of controlling an induction cooking hob.

According to the present invention, there is provided an induction cooking hob according to the independent claim 1.

Preferred non-limiting embodiments of the induction cooking hob are claimed in the claims directly or indirectly depending on claim 1.

In addition, according to the present invention, there is also provided a method for controlling an induction cooking hob according to claim 15.

In addition, according to the present invention, there is provided an induction cooking hob comprising at least one cooking zone for heating a cooking vessel. The cooking zone comprises at least a first induction coil and a second induction coil, the first induction coil and the second induction coil being configured to heat the cooking vessel alone or in collaboration with one another. The induction cooking hob further comprises a power unit operatively connected to and configured to power the first induction coil and the second induction coil and a control interface configured to receive a requested power from a user, the requested power defining and/or being indicative about the power to be delivered to the cooking vessel. The power unit is configured to power the first induction coil and the second induction coil such that the first induction coil delivers, in use, a first power ranging between a first minimum deliverable power and a first maximum deliverable power and the second induction coil delivers, in use, a second power ranging between a second minimum deliverable power and a second maximum deliverable power. Each of the first minimum deliverable power, the first maximum deliverable power, the second minimum deliverable power and the second maximum deliverable power being larger than zero Watt.

Advantageously, the power unit is configured to power the first induction coil and the second induction coil according to a respective powering scheme chosen from a set of powering schemes and the power unit is configured to choose the respective powering scheme in function of the requested power and the first minimum deliverable power, the second minimum deliverable power, the first maximum deliverable power and the second maximum deliverable power.

According to the present invention, the term minimum deliverable power indicates the minimum power of the respective induction coil, which can be delivered by the respective induction coil, when the power units powers the respective induction coil; i.e. when the power unit actuates a current larger than zero ampere (>0 A) flowing through the respective induction coil. This means that the term minimum deliverable power does not comprise the case, when the power unit does not power the respective induction coil; i.e. this does not comprise the case, when the respective induction coil does not receive a current.

In other words, the first minimum deliverable power and the second minimum deliverable power are powers, which can be obtained when the power unit powers respectively the first induction coil and the second induction coil.

In even other words, the first minimum deliverable power and the second minimum deliverable power are powers, which can be obtained when the power unit directs a respective current being larger than zero ampere through respectively the first induction coil and the second induction coil.

Accordingly, when referring to the terms first minimum deliverable power and second minimum deliverable power, one refers to powers being larger than zero Watt (>0 W).

It should be noted that the respective minimum deliverable powers (i.e. the first minimum deliverable power and the second minimum deliverable power) are dependent on the respective physical properties of the respective induction coil (i.e. respectively of the first induction coil and the second induction coil).

Moreover, both the respective first minimum deliverable power and the respective first maximum deliverable power of the first induction coil are larger than zero Watt and both the respective second minimum deliverable power and the respective second maximum deliverable power of the second induction coil are larger than zero Watt.

Moreover, the term “configured to power” does not comprise the case that the power unit does not power the first induction coil and/or the second induction coil at which the first induction coil and/or the second induction coil are switched off (i.e. no generation of a respective electromagnetic field).

According to some preferred non-limiting embodiments, the first induction coil and the second induction coil are coaxial and/or are bifilar and/or are D-shaped.

According to some preferred non-limiting embodiments, the power unit comprises a first generator connected to and configured to power the first induction coil and a second generator connected to and configured to power the second induction coil. The first generator comprises a first inverter and the second generator comprises a second inverter.

Preferentially, the power unit is configured to apply a first gate drive signal to the first inverter and to apply a second gate drive signal to the second inverter so that the first gate drive signal and the second gate drive signal vary in dependence on the respective powering scheme chosen from the set of powering schemes.

According to some preferred non-limiting embodiments, the first minimum deliverable power is smaller than or equals the second minimum power and the first maximum deliverable power is larger than the second minimum power and equals or is smaller than the second maximum power. Preferentially, the first minimum power and the second minimum power are smaller than the first maximum power and the second maximum power.

According to some preferred non-limiting embodiments, the power unit is configured to execute, in particular during execution of the chosen powering scheme, a plurality of duty cycles, in particular each duty cycle lasting for a (static and/or adaptable) duty cycle period.

According to some preferred non-limiting embodiments, the power unit is configured to power the first induction coil and the second induction coil according to a first powering scheme if the requested power is lower than the first minimum power and the second minimum power.

Preferentially but not necessarily, the power unit is configured to power, in use and in particular during execution of each duty cycle, the first induction coil at the first minimum power for a first time period and the second induction coil at the second minimum power for a second time period distinct from the first time period during the execution of the first powering scheme. Preferentially but not necessarily, the first time period and the second time period are chosen so that the delivered overall power corresponds to the requested power.

According to some preferred non-limiting embodiments, the power unit is configured to power the first induction coil and the second induction coil according to a second powering scheme if the requested power is larger than the first maximum power and the second maximum power. Preferentially, the power unit is configured to feed during the execution of the second powering scheme, and in particular during execution of each duty cycle, a first power signal to the first induction coil and a second power signal to the second induction coil, wherein a difference between a period of the second power signal and a period of the first power signal is kept fixed. Preferentially but not necessarily, the difference ranges between fps to 3 μs, most preferentially being 2 μs.

Preferentially but not necessarily, the first power signal and the second power signal have the same shape and/or amplitude.

According to some preferred non-limiting embodiments, the power unit is configured to power the first induction coil and the second induction coil according to a third powering scheme and/or a fourth powering scheme and/or a fifth powering scheme if the requested power is larger than the lower one of the first minimum deliverable power and the second minimum deliverable power and lower than the higher one of the first maximum deliverable power and the second maximum deliverable power.

Preferentially, the power unit is configured to power during the execution of the third powering scheme the first induction coil for a first time period and the second induction coil for a second time period distinct from the first time period and such that the respective delivered averaged power equals the requested power.

Preferentially, the power unit is configured to power the first induction coil and the second induction coil according to the third powering scheme if the requested power is larger than the first minimum deliverable power and the second minimum deliverable power and is smaller than the first maximum deliverable power and the second maximum deliverable power.

Preferentially, the power unit is configured to power the first induction coil and the second induction coil such that the respective delivered first power by the first induction coil and the respective delivered second power by the second induction coil equals the requested power and/or the first time period and the second time period equal one another during the execution of the third powering scheme.

According to some preferred non-limiting embodiments, the power unit is configured to power the first induction coil and the second induction coil according to the third powering scheme or the fourth powering scheme if the requested power ranges between the first minimum deliverable power and the second minimum deliverable power.

According to some preferred non-limiting embodiments, the power unit is configured to power the first induction coil and the second induction coil according to the third powering scheme or the fifth powering scheme if the requested power ranges between the first maximum deliverable power and the second maximum deliverable power.

Preferentially, the power unit is configured to power during the execution of the fourth powering scheme, only the first induction coil if the first minimum deliverable power is smaller than the requested power and only the second induction coil if the second minimum deliverable power is smaller than the requested power.

Preferentially, the power unit is configured to power during the execution of the fifth powering scheme, only the first induction coil if the second maximum deliverable power is smaller than the requested power and only the second induction coil if the first maximum deliverable power is smaller than the requested power.

In addition, according to the present invention, there is also provided a method for controlling an induction cooking hob, in particular the above-disclosed induction cooking hob, comprising at least one cooking zone for heating a cooking vessel. The cooking zone comprises at least a first induction coil and a second induction coil, the first induction coil and the second induction coil being configured to heat the cooking vessel alone or in collaboration with one another. The first induction coil is adapted to deliver a first power ranging between a first minimum deliverable power and a first maximum deliverable power and the second induction coil is adapted to deliver, a second power ranging between a second minimum deliverable power and a second maximum deliverable power.

Advantageously, the method comprises at least the steps of:
receiving a requested power from a user, the requested power defining and/or being indicative about the power to be delivered to the cooking vessel;
powering the first induction coil and the second induction coil, during which the power unit powers the first induction coil and the second induction coil according to a respective powering scheme chosen from a set of powering schemes and the power unit chooses the respective powering scheme in function of the requested power and the first minimum deliverable power, the second minimum deliverable power, the first maximum deliverable power and the second maximum deliverable power.

It should be noted that each of the first minimum deliverable power, the first maximum deliverable power, the second minimum deliverable power and the second maximum deliverable power is larger than zero Watt.

According to some preferred non-limiting embodiments, the first induction coil and the second induction coil are coaxial and/or bifilar and/or each has a D-shape.

According to some preferred non-limiting embodiments, during the step of powering, a first gate drive signal is applied to a first inverter of a first generator connected to the first induction coil and a second gate drive signal is applied to a second inverter of a second generator connected to the second induction coil. In particular, during the step of powering, the first gate drive signal is applied to the first inverter and the second gate drive signal is applied to the second inverter so that the first gate drive signal and the second gate drive signal vary in dependence on the respective powering scheme chosen from the set of powering schemes.

According to some preferred non-limiting embodiments, the first minimum deliverable power is smaller or equals the second minimum power and the first maximum deliverable power is larger than the second minimum power and equals or is smaller than the second maximum power. In particular, the first maximum power and the second maximum power are larger than the first minimum power and the second minimum power.

According to some preferred non-limiting embodiments, during the execution of the step of powering, and in particular during execution of the chosen powering scheme, a plurality of duty cycles, in particular each duty cycle lasting for a (static and/or adaptable) duty cycle period, are executed.

According to some preferred non-limiting embodiments, during the step of powering, the power unit powers the first induction coil and the second induction coil according to a first powering scheme if the requested power is lower than the first minimum power and the second minimum power.

Preferentially, during the execution of the first powering scheme and during execution of each duty cycle, the power unit powers the first induction coil at the first minimum power for a first time period and the second induction coil at the second minimum power for a second time period distinct from the first time period.

Even more preferentially, the first time period and the second time period are chosen so that the delivered overall power corresponds to the requested power.

According to some preferred non-limiting embodiments, during the step of powering, the power unit powers the first induction coil and the second induction coil according to a second powering scheme if the requested power is larger than the first maximum power and the second maximum power.

Preferentially, the power unit feeds during the execution of the second powering scheme and in particular during execution of each duty cycle, a first power signal to the first induction coil and a second power signal to the second induction coil, wherein a difference between a period of the second power signal and a period of the first power signal is kept fixed. Preferentially but not necessarily, the difference ranges between fps to 3 μs, most preferentially being 2 μs.

According to some preferred non-limiting embodiments, the first power signal and the second power signal have the same shape and/or amplitude.

According to some preferred non-limiting embodiments, during the step of powering, the power unit powers the first induction coil and the second induction coil according to a third powering scheme and/or a fourth powering scheme and/or a fifth powering scheme if the requested power is larger than the lower one of the first minimum deliverable power and the second minimum deliverable power and lower than the higher one of the first maximum deliverable power and the second maximum deliverable power.

Preferentially, the power unit powers during the execution of the third powering scheme and in particular during execution of each duty cycle, the first induction coil for a first time period and the second induction coil for a second time period distinct from the first time period and such that the respective delivered averaged power equals the requested power.

According to some preferred non-limiting embodiments, the power unit chooses the third powering scheme if the requested power is larger than the first minimum deliverable power and the second minimum deliverable power and is smaller than the first maximum deliverable power and the second maximum deliverable power,

According to some preferred non-limiting embodiments, the power unit powers, during execution of the third powering scheme and in particular during execution of each duty cycle, the first induction coil and the second induction coil such that the respective delivered first power by the first induction coil and the respective delivered second power by the second induction coil equals the requested power and/or the first time period and the second time period equal one another.

According to some preferred non-limiting embodiments, the power unit powers the first induction coil and the second induction coil according to the third powering scheme or the fourth powering scheme if the requested power ranges between the first minimum deliverable power and the second minimum deliverable power.

According to some preferred non-limiting embodiments, the power unit powers the first induction coil and the second induction coil according to the third powering scheme or the fifth powering scheme if the requested power ranges between the first maximum deliverable power and the second maximum deliverable power.

Preferentially, the power unit powers during the execution of the fourth powering scheme and in particular during each duty cycle, only the first induction coil if the first minimum deliverable power is smaller than the requested power and only the second induction coil if the second minimum deliverable power is smaller than the requested power.

Preferentially, the power unit powers during the execution of the fifth powering scheme, only the first induction coil if the second maximum deliverable power is smaller than the requested power and only the second induction coil if the first maximum deliverable power is smaller than the requested power.

Three non-limiting embodiments of the present invention will now be described, by way of example, with reference to the accompanying drawings, in which:

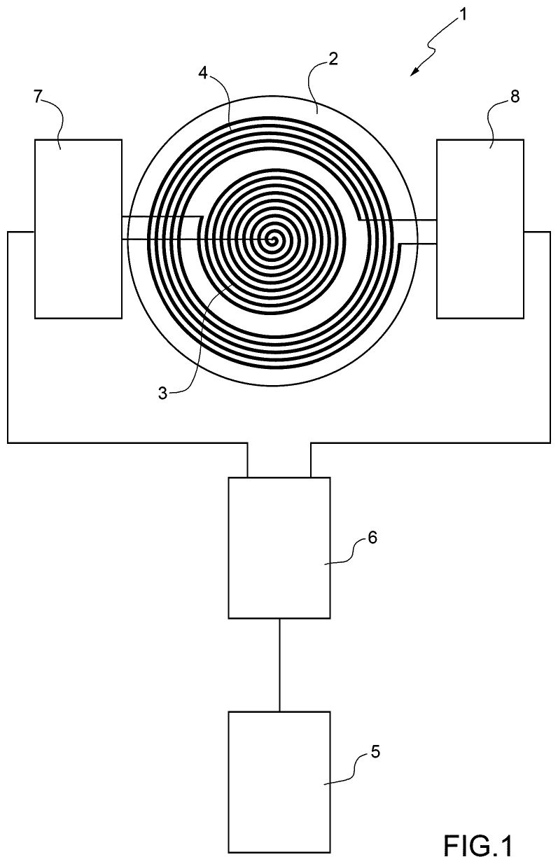

FIG. 1 is a schematic view of a cooking hob according to a first embodiment of the present invention, with parts removed for clarity;

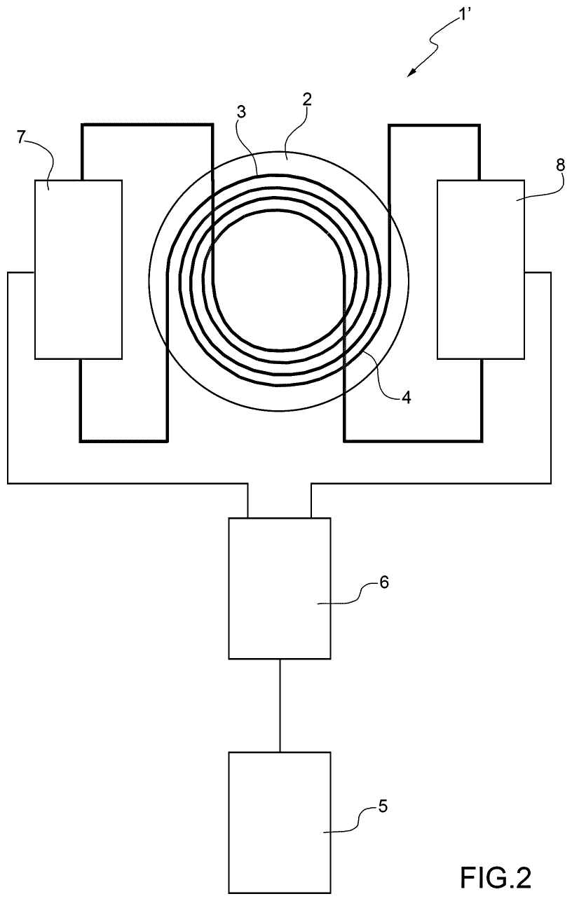

FIG. 2 is a schematic view of a cooking hob according to a second embodiment of the present invention, with parts removed for clarity; and

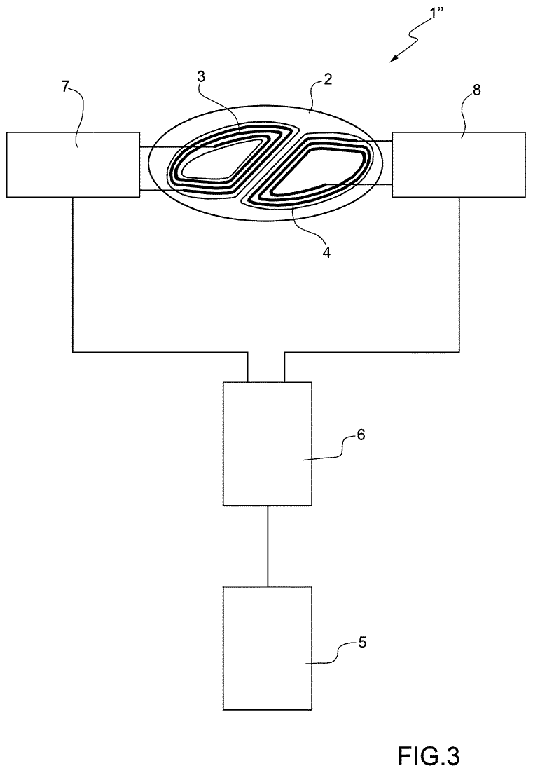

FIG. 3 is a schematic view of a cooking hob according to a third embodiment of the present invention, with parts removed for clarity.

With particular reference to FIG. 1, number 1 indicates as a whole a cooking hob for heating one or more cooking vessels, such as pots, pans, kettles or the like.

In more detail, cooking hob 1 comprises at least one cooking zone configured to heat at least one cooking vessel, in particular for heating a food product present within the cooking vessel.

In further detail, cooking zone 2 comprises at least a first induction coil 3 and a second induction coil 4 configured to heat the respective cooking vessel alone or in collaboration with one another. In particular, as will be explained in more detail further below, there are conditions in which it is possible to power only one of induction coils 3 and 4 so as to heat the cooking vessel, while there are other conditions, which require the powering of both induction coils 3 and 4.

Preferentially, cooking zone 2 comprises a support surface for carrying the respective cooking vessel. In particular, induction coils 3 and 4 are arranged below the respective support surface (i.e. the support surface is, in use, interposed between induction coils 3 and 4 and the cooking vessel.

According to some possible non-limiting embodiments, cooking zone 2 could comprises further induction coils in addition to induction coils 3 and 4.

According to some possible non-limiting embodiments, cooking hob 1 could comprise a continuous surface, such as a glass-ceramic surface, and the support surface is defined by a respective zone of the continuous surface.

According to some possible non-limiting embodiments, induction coil 3 and induction coil 4 are wound in a flat configuration and each covers a respective area.

According to the example shown in FIG. 1, induction coil 3 and induction coil 4 are coaxially arranged to one another. In particular, induction coil 3 is surrounded by induction coil 4. Even more particular, induction coil 3 is a circular induction coil and induction coil 4 is a ring induction coil.

Advantageously, cooking hob 1 further comprises a control interface 5 configured to interact with a user for selectively controlling operation of cooking zone 2.

In particular, control interface 5 is configured to receive a requested power from the user, the requested power defining and/or being indicative about the power to be delivered to the cooking vessel. Even more particular, control interface 5 is configured to allow for a modification of the requested power during a cooking process.

According to some possible non-limiting embodiments, control interface 5 comprises one or more control buttons (digital and/or analogue) configured to be manipulated by the user so as to receive the requested power. In particular, control interface 5 is configured to allow for the user to set the requested power by means of a qualitative pointer, such as e.g. a series of continuous or discrete numbers ranging from a minimum to a maximum for setting the requested power between and including a minimum and a maximum or a modifiable scale or similar.

Advantageously, cooking hob 1 also comprises a power unit 6 operatively connected to and configured to (selectively) power first induction coil 3 and second induction coil 4.

In more detail, power unit 6 is configured to power the respective induction coils 3 and 4 such that the respective first induction coil 3 delivers, in use, a respective first power ranging between a respective first minimum deliverable power and a respective first maximum deliverable power and the respective second induction coil delivers, in use, a respective second power ranging between a second minimum deliverable power and a respective second maximum deliverable power.

Each of the first minimum deliverable power, the first maximum deliverable power, the second minimum deliverable power and the second maximum deliverable power is larger than zero Watt.

According to some possible non-limiting embodiments, the first minimum deliverable power is smaller than the second minimum power and the first maximum deliverable power is larger than the second minimum power and equals or is smaller than the second maximum power. In particular, the first and second minimum power are smaller than the first and second maximum power.

Alternatively, the first minimum deliverable power and the second minimum deliverable power could equal one another and the first maximum deliverable power and the second maximum deliverable power could equal one another. Furthermore, the first and second maximum deliverable power could be larger than the first minimum deliverable power and the second minimum deliverable power.

According to some possible non-limiting embodiments, power unit 6 operates in quasi-resonator architecture for powering induction coils 3 and 4.

Advantageously, power unit 6 is configured to power induction coil 3 and induction coil 4 according to a respective powering scheme chosen from a set of powering schemes. In particular, power unit 6 is configured to choose the respective powering scheme in function of the requested power and the first minimum deliverable power, the second minimum deliverable power, the first maximum deliverable power and the second maximum deliverable power.

According to some possible non-limiting embodiments, power unit 6 comprises a first generator 7 connected to and configured to power induction coil 3 and a second generator 8 connected to and configured to power induction coil 4.

In particular, generator 7 comprises a first inverter and generator 8 comprises a second inverter.

Preferentially, power unit 6 is configured to apply a first gate drive signal to the first inverter and to apply a second gate drive signal to the second inverter so that the first gate drive signal and the second gate drive signal vary in dependence on the respective powering scheme chosen from the set of powering schemes.

Preferentially, power unit 6 is configured to choose from a set of at least a first powering scheme, a second powering scheme and a third powering scheme. According to some possible non-limiting embodiments, power unit 6 is configured to choose from a set having also a fourth powering scheme and/or a fifth powering scheme.

Preferentially, power unit 6 is configured to execute, in particular during execution of the chosen powering scheme, a plurality of duty cycles, in particular each duty cycle lasting for a (static and/or adaptable) duty cycle period.

In particular, power unit 6 is configured to power induction coils 3 and 4 according to the following:
if the requested power is lower than the first minimum power and the second minimum power the first powering scheme is chosen; and/or
if the requested power is larger than the first maximum power and the second maximum power, the second powering scheme is chosen.

Preferentially, power unit 6 is configured to power induction coils 3 and 4 according to the third powering scheme and/or the fourth powering scheme and/or the fifth powering scheme if the requested power is larger than the lower one of the first minimum deliverable power and the second minimum deliverable power and lower than the higher one of the first maximum deliverable power and the second maximum deliverable power.

Preferentially, power unit 6 is configured such that, in use, during the execution of the first powering scheme, power unit 6 powers, in particular during one duty cycle period, induction coil 3 at the first minimum power for a first time period and induction coil 4 at the second minimum power for a second time period distinct from the first time period (i.e. power unit 6 is configured to power e.g. at first induction coil 3 and then induction coil 4). In particular, in use, during the execution of the first powering scheme, in use, the first time period and the second time period are chosen so that the delivered overall power corresponds to the requested power.

In particular, the sum of the first time period and of the second time period is less than the duty cycle period.

In more detail, the respective duty cycles (DC) of induction coil 3 and 4 are dependent on the requested power and respectively the first minimum and maximum deliverable power and the second minimum and maximum deliverable power.

More Specifically, the Duty Cycles are Determined as:

DCⁱ_{coil}=PW/(LPW³+LPW⁴), with 3 or 4 being indicative of respectively coil 3 and 4 and PW is the requested power, LPWⁱ is the respective first or second minimum deliverable power.

Preferentially, power unit 6 is configured to feed during the execution of the second powering scheme a first power signal to induction coil 3 and a second power signal to induction coil 4 so that a difference between a period of the second power signal and a period of the first power signal is kept fixed. Such a difference may range between fps to 3 μs, in particular such a difference may equal 2 μs.

Preferentially, the first power signal and the second power signal have the same shape and/or amplitude.

In more detail, power unit 6 is configured to apply, when executing, in use, the second powering scheme, a first gate driving signal to the first inverter and a second gate driving signal to the second inverter. A difference between a period of the first gate driving signal and a period of the second gate driving signal may be fixed. In particular, such a difference may range between fps to 3 μs, most preferentially may equal 2 μs.

Preferentially, the first gate driving signal and the second gate driving signal have the same shape and/or amplitude.

Preferentially, power unit 6 is configured to power during the execution of the third powering scheme and in particular during each duty cycle, induction coil 3 for a first time period and second induction coil 4 for a second time period distinct from the first time period and such that the respective delivered averaged power equals the requested power.

In particular, the first time period and the second time period are a function of the requested power and respectively the first minimum deliverable power and the second maximum deliverable power and the second minimum deliverable power and the second maximum deliverable power.

In particular, power unit 6 is configured to power induction coils 3 and 4 according to the third powering scheme, if the requested power is larger than the first minimum deliverable power and the second minimum deliverable power and if the requested power is smaller than the first maximum deliverable power and the second maximum deliverable power.

Preferentially, power unit 6 is configured to power, during execution of the third powering scheme and in particular during execution of each duty cycle, induction coil 3 and induction coil 4 such that the respective delivered first power by induction coil 3 and the respective delivered second power by induction coil 4 equals the requested power and/or the first time period and the second time period equal one another.

According to some possible non-limiting embodiments, during execution of the third powering scheme and in particular each duty cycle, the sum of the first time period and the second time period correspond to the duty cycle period.

According to some possible embodiments, if the requested power ranges between the first minimum deliverable power and the second minimum deliverable power the power unit is configured to power the first induction coil and the second induction coil according to the third powering scheme or the fourth powering scheme.

In particular, power unit 6 is configured to power during the execution of the fourth powering scheme and in particular during each duty cycle, only induction coil 3 if the first minimum deliverable power is smaller than the requested power, and in particular the first maximum deliverable power is larger than the requested power, and only induction coil 4 if the second minimum deliverable power is smaller than the requested power, and in particular the second maximum deliverable power is larger than the requested power. Even more particular, during the execution of the fourth powering scheme and in particular during each duty cycle, the power provided by the active induction coil 3 or 4 equals the requested power.

Preferentially, if the requested power ranges between the first maximum deliverable power and the second maximum deliverable power, power unit 6 is configured to power induction coil 3 and induction coil 4 according to the third powering scheme or the fifth powering scheme.

In particular, power unit 6 is configured to power during the execution of the fifth powering scheme and in particular during each duty cycle, only induction coil 3 if the second maximum deliverable power is smaller than the requested power, and in particular larger than the first minimum deliverable power, and only induction coil 4 if the first maximum deliverable power is smaller than the requested power.

Even more particular, during the execution of the fifth powering scheme the power provided by the active induction coil 3 or 4 equals the requested power.

It should be noted that while execution of the fourth powering scheme and the fifth powering scheme allows fulfilling the power request instantaneously, the execution of the third powering scheme requires a period of some seconds prior to fulfil the power request. Thus, while execution of the fourth powering scheme and the fifth powering scheme leads to a better consumer experience as the heating process is more even, the execution of the third powering scheme allows to balance the stress and the consumption borne by induction coils 3 and 4, in particular both in the short and long term.

In use, operation of cooking hob 1 allows the heating of the cooking vessel, and in particular the simultaneous heating of the food product placed within the cooking vessel.

Operation of cooking hob 1 comprises the method of controlling induction hob 1 and placing the cooking vessel onto cooking zone 2.

In more detail, the method for controlling cooking hob comprises at least the steps of:
receiving a requested power from the user, in particular by means of control interface 5;
powering induction coil 3 and induction coil 4 by means of power unit 6 such that power unit 6 powers induction coil 3 and induction coil 4 according to a respective powering scheme chosen from the set of powering schemes and power unit 6 chooses the respective powering scheme in function of the requested power and the first minimum deliverable power, the second minimum deliverable power, the first maximum deliverable power and the second maximum deliverable power.

Preferentially, during the step of powering, power unit 6 chooses from a set of at least the first powering scheme, the second powering scheme and the third powering scheme. According to some possible non-limiting embodiments, power unit 6 also chooses from a set having also a fourth powering scheme and/or a fifth powering scheme.

According to some preferred non-limiting embodiments, during the execution of the step of powering and in particular during execution of the chosen powering scheme, a plurality of duty cycles, in particular each duty cycle lasting for a (static and/or adaptable) duty cycle period, are executed.

In particular, during the step of powering, power unit 6 applies the first gate drive signal to the first inverter and applies the second gate drive signal to the second inverter. Thereby, the first gate drive signal and the second gate drive signal vary in dependence on the respective powering scheme chosen from the set of powering schemes.

Preferentially, during the step of powering, power unit 6 powers induction coils 3 and 4 according to a first powering scheme if the requested power is lower than the first minimum power and the second minimum power.

In more detail, during the execution of the first powering scheme and in particular during execution of each duty cycle, power unit 6 powers the first induction coil at the first minimum power, in particular during execution of one duty cycle, for the first time period and the second induction coil at the second minimum power for the second time period distinct from the first time period. In particular, the first time period and the second time period are chosen so that the delivered overall power corresponds to the requested power.

Preferentially, during the step of powering, power unit 6 powers induction coil 3 and 4 according to the second powering scheme if the requested power is larger than the first maximum power and the second maximum power. In particular, power unit 6 feeds during the execution of the second powering scheme and in particular during execution of each duty cycle, the first power signal to induction coil 3 and the second power signal to induction coil 4 with a difference between a period of the second power signal and a period of the first power signal being fixed.

According to some possible embodiments, the first power signal and the second power signal have the same shape and/or amplitude when executing the step of powering and when executing the second powering scheme.

According to some possible embodiments, during the step of powering, power unit 6 powers induction coil 3 and induction coil 4 according to the third powering scheme and/or the fourth powering scheme and/or the fifth powering scheme if the requested power is larger than the lower one of the first minimum deliverable power and the second minimum deliverable power and smaller than the higher one of the first maximum deliverable power and the second maximum deliverable power.

Preferentially, power unit 6 powers during the step of powering, during the execution of the third powering scheme and in particular during execution of each duty cycle, induction coil 3 for a first time period and induction coil 4 for a second time period distinct from the first time period such that the respective delivered averaged power equals the requested power.

According to some possible embodiments, power unit 6 powers induction coils 3 and 4 according to the third powering scheme if the requested power is larger than the first minimum deliverable power and the second minimum deliverable power and is smaller than the first maximum deliverable power and the second maximum deliverable power.

According to some possible embodiments, during the execution of the third powering scheme and in particular during execution of each duty cycle, power unit 6 powers induction coils 3 and 4 such that the delivered first power and the respective delivered second power equal the requested power and/or the first time period and the second time period equal one another.

Preferentially, during the step of powering and if the requested power ranges between the first minimum deliverable power and the second minimum deliverable power, power unit 6 powers induction coils 3 and 4 according to the third powering scheme or the fourth powering scheme.

Preferentially, during the step of powering and if the requested power ranges between the first maximum deliverable power and the second maximum deliverable power, power unit 6 powers induction coils 3 and 4 according to the third powering scheme or the fifth powering scheme.

In particular, during the step of powering, the execution of the fourth powering scheme, and in particular during execution of each duty cycle, power unit 6 powers only induction coil 3 if the first minimum deliverable power is smaller than the requested power and only induction coil 4 if the second minimum deliverable power is smaller than the requested power. In other words, one of the coils 3 and 4 heats the cooking vessel and the other one is off.

In particular, during the step of powering, the execution of the fifth powering scheme and in particular during execution of each duty cycle, power unit 6 powers only induction coil 3 if the second maximum deliverable power is smaller than the requested power and only induction coil 4 if the first maximum deliverable power is smaller than the requested power. In other words, one of the coils 3 and 4 heats the cooking vessel and the other one is off.

With reference to FIG. 2, number 1′ indicates an alternative embodiment of a cooking hob according to the present invention; as cooking hob 1′ is similar to cooking hob 1, the following description is limited to the differences between them, and using the same references, where possible, for identical or corresponding parts.

In particular, cooking hob 1′ differs from cooking hob 1 in that induction coil 3 and induction coil 4 are bifilar.

As operation of cooking hob 1′ is identical to operation of cooking hob 1, we refer to the description of the operation of cooking hob 1.

With reference to FIG. 3, number 1″ indicates an alternative embodiment of a cooking hob according to the present invention; as cooking hob 1″ is similar to cooking hob 1 and to cooking hob 1′, the following description is limited to the differences between them, and using the same references, where possible, for identical or corresponding parts.

In particular, cooking hob 1″ differs from cooking hob 1 in that each one of induction coil 3 and induction coil 4 has a D-shape. Furthermore, induction coils 3 and 4 are (adjacent to and) spaced apart from one another.

As operation of cooking hob 1″ is identical to operation of cooking hob 1, we refer to the description of the operation of cooking hob 1.

The advantages of cooking hobs 1, 1′ and 1″ and their respective operation according to the present invention will be clear from the foregoing description.

In particular, cooking hobs 1, 1′ and 1″ allow an increased maximum power delivery to the cooking vessel, in particular when operating in quasi-resonant architecture.

Furthermore, cooking hobs 1, 1′ and 1″ allow a decreased pulsed-power threshold vessel, in particular when operating in quasi-resonant architecture.

Another advantage is seen in that cooking hobs 1, 1′, 1″ suppress the occurrence of acoustic noise during their operation.

Clearly, changes may be made cooking hobs 1, 1′ and 1″ and their respective operations without, however, departing from the scope of the present invention.

### LIST OF REFERENCE NUMERALS

1, 1′, 1″ cooking hob
2 cooking zone
3 first induction coil
4 second induction coil
5 control interface
6 power unit
7 first generator
8 second generator

1. Induction cooking hob comprising a cooking zone for heating a cooking vessel;
wherein the cooking zone comprises a first induction coil and a second induction coil, the first induction coil and the second induction coil being configured to heat the cooking vessel alone or in collaboration with one another;
wherein the induction cooking hob further comprises a power unit operatively connected to and configured to power the first induction coil and the second induction coil and a control interface configured to receive a requested power from a user, the requested power defining and/or being indicative about power to be delivered to the cooking vessel when placed in the cooking zone;
wherein the power unit is configured to power the first induction coil and the second induction coil such that the first induction coil delivers, in use, a first power ranging between a first minimum deliverable power and a first maximum deliverable power and the second induction coil delivers, in use, a second power ranging between a second minimum deliverable power and a second maximum deliverable power;
wherein the power unit is configured to power the first induction coil and the second induction coil according to a respective powering scheme chosen from a set of powering schemes;
wherein the power unit is configured to choose the respective powering scheme as a function of the requested power and the first minimum deliverable power, the second minimum deliverable power, the first maximum deliverable power and the second maximum deliverable power.

2. Induction cooking hob according to claim 1, wherein the power unit comprises a first generator connected to and configured to power the first induction coil and a second generator connected to and configured to power the second induction coil;
wherein the first generator comprises a first inverter and the second generator comprises a second inverter;
wherein the power unit is configured to apply a first gate drive signal to the first inverter and to apply a second gate drive signal to the second inverter so that the first gate drive signal and the second gate drive signal vary in dependence on the respective powering scheme chosen from the set of powering schemes.

3. Induction cooking hob according to claim 1, wherein the first minimum deliverable power is smaller than or equals the second minimum deliverable power and the first maximum deliverable power is larger than the second minimum deliverable power and equals or is smaller than the second maximum deliverable power.

4. Induction cooking hob according to claim 1, wherein the power unit is configured to power the first induction coil and the second induction coil according to a first said powering scheme if the requested power is lower than the first minimum deliverable power and the second minimum deliverable power.

5. Induction cooking hob according to claim 4, wherein the power unit is configured to power, in use, the first induction coil at the first minimum deliverable power for a first time period and the second induction coil at the second minimum deliverable power for a second time period distinct from the first time period during execution of the first said powering scheme, the first time period and the second time period are being chosen so that the delivered overall power corresponds to the requested power.

6. Induction cooking hob according to claim 4, wherein the power unit is configured to power the first induction coil and the second induction coil according to a second said powering scheme if the requested power is larger than the first maximum deliverable power and the second maximum deliverable power.

7. Induction cooking hob according to claim 6, wherein the power unit is configured to feed during execution of the second said powering scheme a first power signal to the first induction coil and a second power signal to the second induction coil-wherein a period of the second power signal is kept at a fixed difference with respect to a period of the first power signal.

8. Induction cooking hob according to claim 6, wherein the power unit is configured to power the first induction coil and the second induction coil according to a third said powering scheme and/or a fourth said powering scheme and/or a fifth said powering scheme if the requested power is larger than the lower one of the first minimum deliverable power and the second minimum deliverable power and lower than the higher one of the first maximum deliverable power and the second maximum deliverable power.

9. Induction cooking hob according to claim 8, wherein the power unit is configured to power during the execution of the third said powering scheme the first induction coil for a first time period and the second induction coil for a second time period distinct from the first time period and such that the respective delivered averaged power equals the requested power.

10. Induction cooking hob according to claim 9, wherein the power unit is configured to power the first induction coil and the second induction coil such that the respective delivered first power by the first induction coil and the respective delivered second power by the second induction coil equals the requested power and/or the first time period and the second time period equal one another, if the requested power is larger than the first minimum deliverable power and the second minimum deliverable power and is smaller than the first maximum deliverable power and the second maximum deliverable power,

11. Induction cooking hob according to claim 8, wherein the power unit is configured to power the first induction coil and the second induction coil according to the third said powering scheme or the fourth said powering scheme if the requested power ranges between the first minimum deliverable power and the second minimum deliverable power; and/or
the power unit is configured to power the first induction coil and the second induction coil according to the third said powering scheme or the fifth said powering scheme if the requested power ranges between the first maximum deliverable power and the second maximum deliverable power.

12. Induction cooking hob according to claim 11, wherein the power unit is configured to power during execution of the fourth said powering scheme, only if the first induction coil if the first minimum deliverable power is smaller than the requested power and only the second induction coil if the second minimum deliverable power is smaller than the requested power.

13. Induction cooking hob according to claim 11, wherein the power unit is configured to power during execution of the fifth said powering scheme, only the first induction coil if the second maximum deliverable power is smaller than the requested power and only the second induction coil if the first maximum deliverable power is smaller than the requested power.

14. Induction cooking hob according to claim 1, wherein the first induction coil and the second induction coil are coaxial and/or are bifilar and/or are D-shaped.

15. Method for controlling the induction cooking hob,
according to claim 1;
the method comprising:
receiving the requested power from a user;
powering the first induction coil and the second induction coil, during which the power unit powers the first induction coil and the second induction coil according to a said respective powering scheme chosen as a function of the requested power and the first minimum deliverable power, the second minimum deliverable power, the first maximum deliverable power and the second maximum deliverable power.

16. Induction cooking hob comprising:
a cooking zone for heating a cooking vessel, the cooking zone comprising a first induction coil and a second induction coil, the first induction coil and the second induction coil being configured to heat the cooking vessel alone or in collaboration with one another;
a control interface configured to receive a requested power from a user, the requested power defining and/or being indicative about power to be delivered to the cooking vessel when placed in the cooking zone; and
a power unit comprising a first generator operatively connected to and configured to power the first induction coil at a first power within a first range from a first minimum deliverable power up to a first maximum deliverable power, and a second generator operatively connected to and configured to power the second induction coil within a second range from a second minimum deliverable power up to a second maximum deliverable power, wherein the first minimum deliverable power is less than or equal to the second minimum deliverable power, the first maximum deliverable power is less than or equal to the second maximum deliverable power, and the first maximum deliverable power is greater than the second minimum deliverable power;
wherein the power unit is configured to power the first induction coil and the second induction coil according to:
a first powering scheme selected from among a set of predetermined powering schemes, if the requested power is lower than the first minimum deliverable power, wherein in the first powering scheme the power unit is configured to power the first induction coil at the first minimum deliverable power for a first time period of a first duty cycle and to power the second induction coil at the second minimum deliverable power for a second time period of the first duty cycle, distinct from the first time period, wherein the first and second time periods are selected so that their sum is less than a total time period of the duty cycle and that a combined overall power delivered by both the first and second induction coils during the duty cycle corresponds to the requested power;
a second powering scheme, selected from among the set of predetermined power schemes, if the requested power is larger than the second maximum deliverable power, wherein in the second powering scheme the power unit is configured to feed a first power signal to the first induction coil for a first time period of a second duty cycle and to feed a second power signal to the second induction coil for a second time period of the second duty cycle, wherein the second time period of the second duty cycle is kept at a fixed difference with respect to the first time period of the second duty cycle; and
a third powering scheme, selected from among the set of predetermined power schemes, if the requested power is larger than the first minimum deliverable power and lower than the second maximum deliverable power, wherein in the third powering scheme the power unit is configured to power the first induction coil for a first time period of a third duty cycle and to power the second induction coil for a second time period of the third duty cycle, distinct from the first time period of the third duty cycle, such that an average of power delivered by both the first induction coil and the second induction coil equals the requested power;
wherein the power unit is configured to choose the respective powering scheme as a function of the requested power and the first minimum deliverable power, the second minimum deliverable power, the first maximum deliverable power and the second maximum deliverable power.
